(19) United States
(12) Patent Application Publication
(10) Pub. No.: US 2026/0336207 A1
(43) Pub. Date: Oct. 29, 2026

(54) APPARATUS AND METHODS FOR DISPENSING DROPLETS

(71) Applicants: CZ BIOHUB SF, LLC, San Francisco, CA (US); THE REGENTS OF THE UNIVERSITY OF CALIFORNIA, Oakland, CA (US)

(72) Inventors: Adam Abate, Oakland, CA (US); Krzysztof Langer, Oakland, CA (US)

(21) Appl. No.: 19/119,719

(22) PCT Filed: Oct. 10, 2023
(86) PCT No.: PCT/US2023/034777

§ 371 Date: Apr. 9, 2025

Related U.S. Application Data
(60) Provisional application No. 63/416,363, filed on Oct. 14, 2022.

(51) Int. Cl. B29C 64/209; B29C 64/106; B33Y 10/00; B33Y 30/00

(52) U.S. Cl. CPC B29C 64/209; B29C 64/106; B33Y 10/00; B33Y 30/00

(57) ABSTRACT

Methods and apparatus for dispensing droplets. In accordance with an implementation, an apparatus includes a dispenser, a liquid source, and a pressure source. The dispenser includes a tube having an outlet, a channel surrounding the tube, a flow path coupling the channel and the outlet of the tube. The liquid source to be coupled to the tube and to contain a liquid and the pressure source to be coupled to the channel. The liquid is to flow from the liquid source through the tube and the pressure source is to flow gas through the channel to cause a droplet of the liquid to be dispensed from the outlet of the tube.

### RELATED APPLICATION

This application claims the benefit of and priority to U.S. Provisional Patent Application Number 63/416,363, filed Oct. 14, 2022, the content of which is incorporated by reference herein in its entireties and for all purposes.

### BACKGROUND

Bioprinting can be used to spatially control the placement of cells in many applications including tissue engineering, organoids, stem cell research, and high-throughput screening.

### SUMMARY

Advantages over the prior art and benefits as described later in this disclosure can be achieved through the provision of apparatus and methods for dispensing droplets. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a dispenser, a liquid source, and a pressure source. The dispenser includes a tube having an outlet, a channel surrounding the tube, and a flow path coupling the channel and the outlet of the tube. The liquid source to be coupled to the tube and to contain a liquid and the pressure source to be coupled to the channel. The liquid is to flow from the liquid source through the tube and the pressure source is to flow gas through the channel to cause a droplet of the liquid to be dispensed from the outlet of the tube.

In accordance with a second implementation, an apparatus includes a dispenser having a tube having an outlet at a flow path and a membrane valve at least partially defining the flow path and actuatable to a first position and a second position. The membrane valve being in the first position causes the flow path to have a first width and the membrane valve being in the second position causes the flow path to have a second width.

In further accordance with the foregoing first and/or second implementations, an apparatus and/or method may further comprise or include any one or more of the following:

In an implementation, the pressure source is to flow the gas at a substantially constant flow rate.

In another implementation, the channel and the tube are coaxial.

In another implementation, the tube includes a capillary.

In another implementation, the capillary includes a glass capillary.

In another implementation, the capillary includes a tip having the outlet.

In another implementation, the tube includes an optical fiber.

In another implementation, the tube includes a microfluidic channel.

In another implementation, the gas includes air.

In another implementation, the apparatus includes a sorting module having a charging electrode, a sorting electrode and a grounded waste channel.

In another implementation, the sorting module includes an insulator.

In another implementation, the apparatus includes a second dispenser and a mover. The mover to carry the dispenser and the second dispenser.

In another implementation, the dispenser carries a first actuator and the second dispenser carries a second actuator.

In another implementation, the first actuator and the second actuator enable relative movement between the dispenser and the second dispenser.

In another implementation, the liquid includes an emulsion.

In another implementation, the dispenser includes a channel surrounding the tube and the flow path coupling the channel and the outlet of the tube. The apparatus includes a pressure source to be coupled to the channel. The pressure source is to flow gas through the channel.

In another implementation, the first width is between about 60 micrometers and about 310 micrometers.

In another implementation, the second width is between about 60 micrometers and about 310 micrometers.

In another implementation, the first width is between about 60 micrometers and about 170 micrometers and the second width is between about 170 micrometers and about 310 micrometers.

In another implementation, the first width is between about 10 micrometers and about 5,000 micrometers.

In another implementation, the second width is between about 11 micrometers and about 10,000 micrometers.

In another implementation, the first width is between about 10 micrometers and about 170 micrometers and the second width is between about 170 micrometers and about 310 micrometers.

In another implementation, the apparatus includes a second membrane valve opposing the membrane valve and at least partially defining the flow path and actuatable to the first position and the second position.

In another implementation, the apparatus also includes a liquid source to be coupled to the tube and to contain a liquid. The liquid is to flow from the liquid source through the tube. The membrane valve being in the first position causes a first droplet of the liquid to be dispensed from the outlet of the tube and the membrane valve being in the second position causes a second droplet of the liquid to be dispensed from the outlet of the tube. The first droplet having a first size and the second droplet having a second size.

In another implementation, the apparatus also includes a second dispenser coupled to the dispenser.

In another implementation, the dispenser includes a pair of channels on either side of the tube and the flow path coupling the channels and the outlet of the tube. The apparatus includes a pressure source to be coupled to the channels. The pressure source is to flow gas through the channels.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 is a schematic diagram of a system in accordance with teachings of this disclosure.

FIG. 2 is a schematic diagram of another system in accordance with teachings of this disclosure.

FIG. 3 is a schematic diagram of another system in accordance with teachings of this disclosure.

FIG. 4 is a schematic diagram of another system in accordance with teachings of this disclosure.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

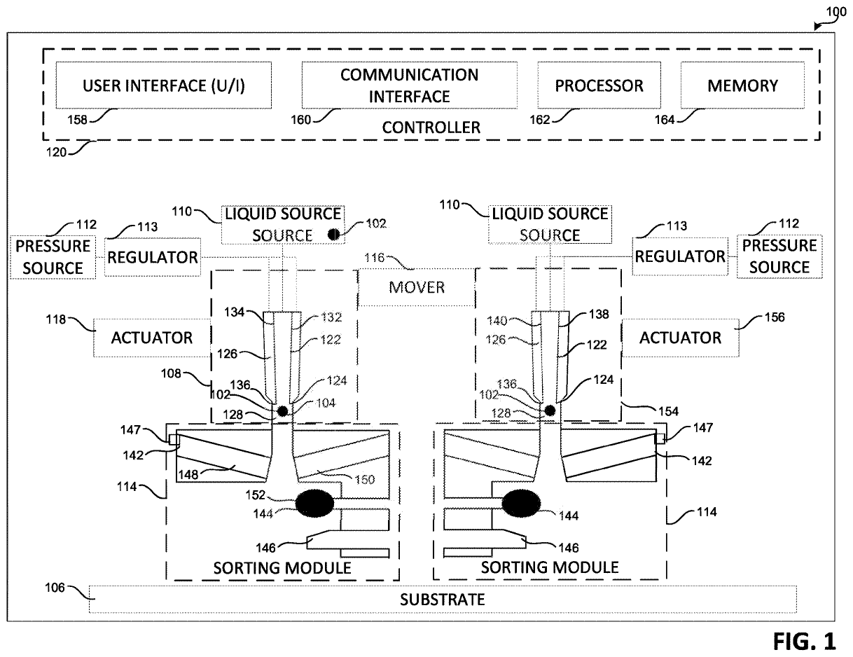

FIG. 1 is a schematic diagram of a system 100 in accordance with teachings of this disclosure. The system 100 can be used to dispense a liquid 102 such as a droplet 104 onto a substrate 106. The system 100 may dispense 3,000 droplets in about one second in some implementations. The liquid 102 may be referred to as a substance, may include cells, spheroids, organoids, glass or polymer beads, chemicals, biomolecules, and/or may be an emulsion. The system 100 may be used for in-situ bioprinting in plastic surgery and/or in diabetes treatment of ulcers as examples. The system 100 may be used for different applications, however.

The system 100 includes a dispenser 108, a liquid source 110, a pressure source 112, and a regulator 113. The dispenser 108 may be referred to as a printhead. The system also includes a sorting module 114, a mover 116, an actuator 118, and a controller 120. The mover 116 may include and/or be implemented by a robotic arm and/or a liquid handling robot. The regulator 113 may be used to regulate a flow of the gas from the pressure source 112 to the dispenser 108, for example. The controller 120 is electrically and/or communicatively coupled to the dispenser 108, the liquid source 110, the regulator 113, the sorting module 114, the mover 116, and/or the actuator 118 to perform various functions as disclosed herein.

The dispenser 108 includes a tube 122 having an outlet 124 and a channel 126 surrounding the tube 122. The dispenser 108 also includes a flow path 128 that couples the channel 126 and the outlet 124 of the tube 122. The flow path 128 may be referred to as an air-liquid co-flow junction. The approach of the channel 126 surrounding the tube 122 may be referred to as co-flow.

The liquid source 110 is shown coupled to the tube 122 and contains the liquid 102 and the pressure source 112 is coupled to the channel 126. The liquid 102 flows from the liquid source 110 through the tube 122 in operation and the pressure source 112 flows gas through the channel 126 to cause the droplet 104 of the liquid 102 to be dispensed from the outlet 124 of the tube 122. The pressure source 112 flows the gas at a substantially constant flow rate in some implementations. The gas may be air. Other gases may prove suitable, however.

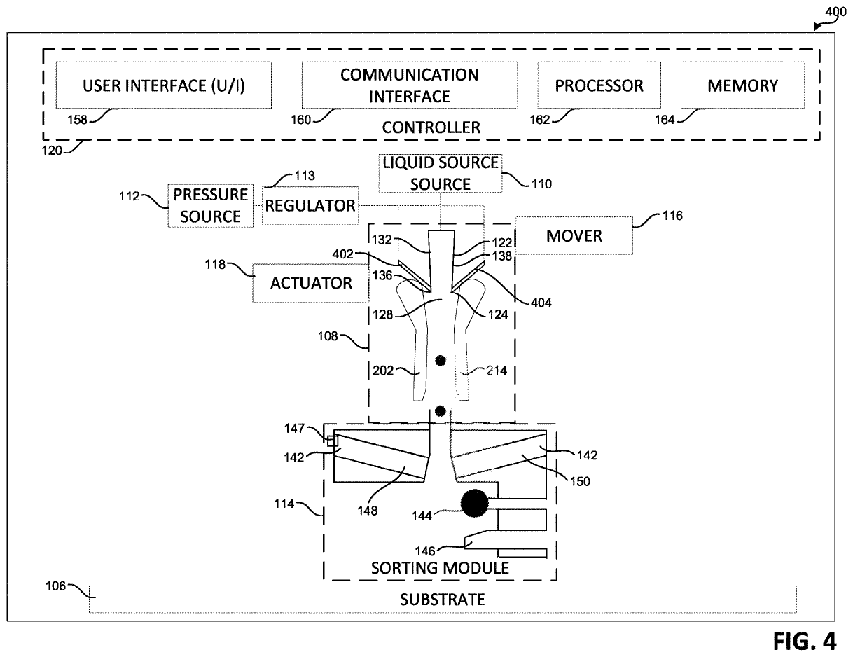

The channel 126 and the tube 122 are coaxial in the implementation shown. The channel 126 may alternatively not surround and/or may not be coaxial with the tube 122. The channel 126 may positioned on a side of the tube 122 and coupled to the flow path 128 in such implementations (see one of the channels of FIG. 4, for example).

The tube 122 may be a capillary 132 such as a glass capillary 134. The capillary 132 has a tip 136 that includes the outlet 124. The tube 122 may additionally or alternatively be an optical fiber 138 and/or a microfluidic channel 140. The optical fiber 138 may be hollow in such implementations.

The sorting module 114 includes a charging electrode 142, a sorting electrode 144, and a grounded waste channel 146. The charging electrode 142 may include a light source 147, optical fibers 148, and/or optical fibers 150. The light source 147 may be a laser and/or a light-emitting diode(s) (LED). The LED may operate at a desired wavelength and/or be associated with a filter(s). The optical fibers 148 and/or 150 may include a conductive coating that removes static charge from the cladding of the optical fibers.

The light source 147 is connected to optical fibers 148, the optical fibers 148 apply excitation energy from the light source 147 to the droplet 104 flowing through the flow path 128, and the optical fibers 150 collect a signal produced by the application of excitation energy 108 to the droplet 104. The signal may be associated with an optical property of the droplet 104, for example.

The sorting electrode 144 can sort the droplet 104 based on the detection of the optical property. The droplet 104 is deposited on the substrate 106 when the sorting electrode 144 is turned on and the droplet 104 is directed to the waste channel 146 when the sorting electrode 144 is turned off in some implementations. The droplet 104 may alternatively be deposited on the substrate 106 when the sorting electrode 144 is turned off and the droplet 104 may be directed to the grounded waste channel 146 when the sorting electrode 144 is turned on in other implementations. The waste channel 146 being grounded deters static charge buildup that may inadvertently defect the droplet 104 away from the waste channel 146. The sorting module 114 includes an insulator 152 in the implementation shown. The insulator 152 is shown on and/or around the sorting electrode 144. The insulator 152 may deter electrical short circuits between the sorting electrode 114 and the grounded waste channel 146 and, thus, may increase the useful life of the sorting module 114.

The system 100 also includes a second dispenser 154 and the mover 116 that carries the dispenser 108 and the second dispenser 154. The mover 116 moves the dispensers 108, 154 relative to the substrate 106 in operation to allow the droplets 104 to be dispensed on the substrate 106, for example. The dispensers 108 and/or 154 can independently dispense droplets 104 or may dispense droplets 104 in parallel. The second dispenser 154 is the same as the dispenser 108 in the implementation shown. The system 100 may include any number of dispensers (e.g., 1, 2, 3, 4, 5, 6, 7, 8 . . . , 12, . . . 50), however.

The dispenser 108 carries the first actuator 118 and the second dispenser 154 carries a second actuator 156. The actuator 118 and/or the second actuator 156 may be implemented by direct drive linear actuators, for example. Other types of actuators may be used, however. The first actuator 118 and the second actuator 156 enable relative movement between the dispenser 108 and the second dispenser 154. The actuator 118 may move the dispenser 108 in the x-direction relative the second dispenser 154 and/or the substrate 106 and/or the second actuator 156 may move the second dispenser 154 in the x-direction relative to the dispenser 108 and/or the substrate 106, for example.

Referring to the controller 120, in the implementation shown, the controller 120 includes a user interface 158, a communication interface 160, one or more processors 162, and a memory 164 storing instructions executable by the one or more processors 162 to perform various functions including the disclosed implementations. The user interface 158, the communication interface 160, and the memory 164 are electrically and/or communicatively coupled to the one or more processors 162.

In an implementation, the user interface 158 is adapted to receive input from a user and to provide information to the user associated with the operation of the system 100 and/or a dispensing operation taking place. The user interface 158 may include a touch screen, a display, a keyboard, a speaker(s), a mouse, a track ball, and/or a voice recognition system. The touch screen and/or the display may display a graphical user interface (GUI).

In an implementation, the communication interface 160 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with droplet dispensing and/or a protocol(s) to be executed by the system 100.

The one or more processors 162 and/or the system 100 may include one or more of a processor-based system(s) or a microprocessor-based system(s). In some implementations, the one or more processors 162 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit and/or another logic-based device executing various functions including the ones described herein.

The memory 164 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache, and/or any other storage device or storage disk in which information is stored for any duration (e.g., permanently, temporarily, for extended periods of time, for buffering, for caching).

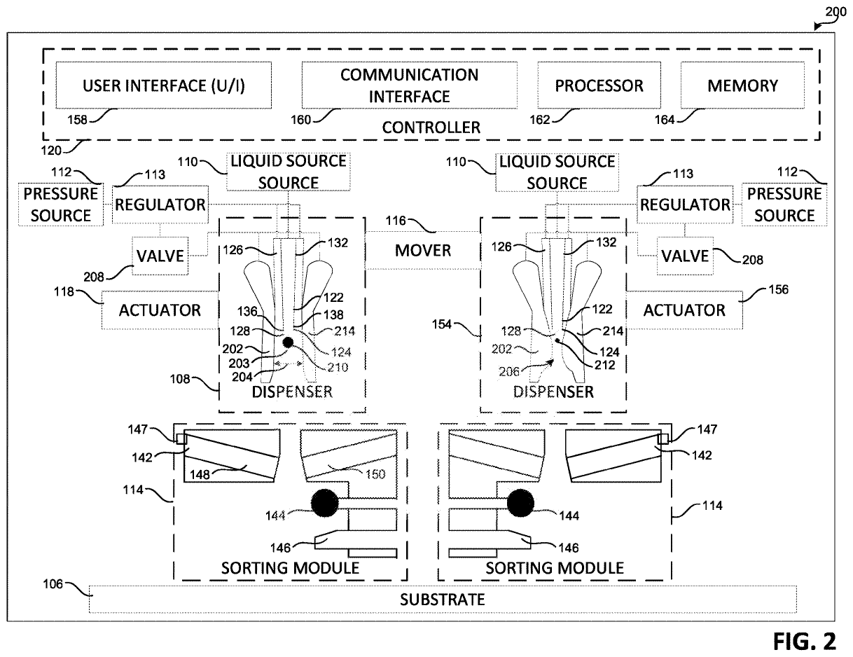

FIG. 2 is a schematic diagram of another system 200 in accordance with teachings of this disclosure. The system 200 is similar to the system 100 of FIG. 1. The dispenser 108 of system 200 includes a membrane valve 202 however at least partially defines the flow path 128 and that is actuatable to a first position and a second position. The membrane valve 202 may include an elastomeric material that is flexible between different positions based on the pressure applied, for example.

The membrane valve 202 of the dispenser 108 is shown in the first position and the membrane valve 202 of the second dispenser 154 is shown in the second position. The membrane valve 202 being in the first position causes the flow path 128 to have a first width 204 and the membrane valve 202 being in the second position causes the flow path 128 to have a second width 206. The membrane valve 202 changes a width of the flow path 128 in a droplet generating region 203 of the flow path 128.

The membrane valve 202 may also be positioned in a third position between the first position and the second position. The membrane valve 202 may be dynamically adjusted to any number of positions to define different widths for the flow path 128 and, therefore, control a size of the droplets 108 being generated and dispensed as a result.

The first width 204 may between about 60 micrometers and about 310 micrometers and/or the second width 206 may be between about 60 micrometers and about 310 micrometers. The first width 204 may alternatively be between about 60 micrometers and about 170 micrometers and/or the second width 206 may alternatively been between about 170 micrometers and about 310 micrometers. The first width 204 may alternatively be between about 10 micrometers and about 5,000 micrometers and/or the second width 206 may be between about 11 micrometers and about 10,000 micrometers. The first width 204 may alternatively be between about 10 micrometers and about 170 micrometers and/or the second width 206 is between about 170 micrometers and about 310 micrometers.

The membrane valve 202 being in the first position in operation causes a first droplet 210 of the liquid 102 to be dispensed from the outlet 124 of the tube 122 and the membrane valve 202 being in the second position causes a second droplet 212 of the liquid 102 to be dispensed from the outlet 124 of the tube 122. The first droplet 210 has a first size and the second droplet 212 has a second size. The first size is larger than the second size as shown. The membrane valve 202 dynamically adjusting the width of the flow path 128 allows the dispenser 108 to dynamically dispense droplets 104 of different sizes.

A valve 208 is coupled between the pressure source 112 and the membrane valve 202. The valve 208 controls the flow of fluid to the membrane valve 202. The fluid actuates the membrane valve 202 in operation. The membrane valve 202 may be actuated using gas and/or a liquid such as hydraulic fluid. The membrane valve 202 may be coupled to a liquid source instead of the pressure source 112 if liquid is used to actuate the membrane valve 202.

The dispenser 108 of the system 200 is also shown including a second membrane valve 214 that opposes the membrane valve 202. The second membrane valve 214 at least partially defines the flow path 128 and is actuatable to the first position and the second position. The second membrane valve 214 may alternatively be omitted.

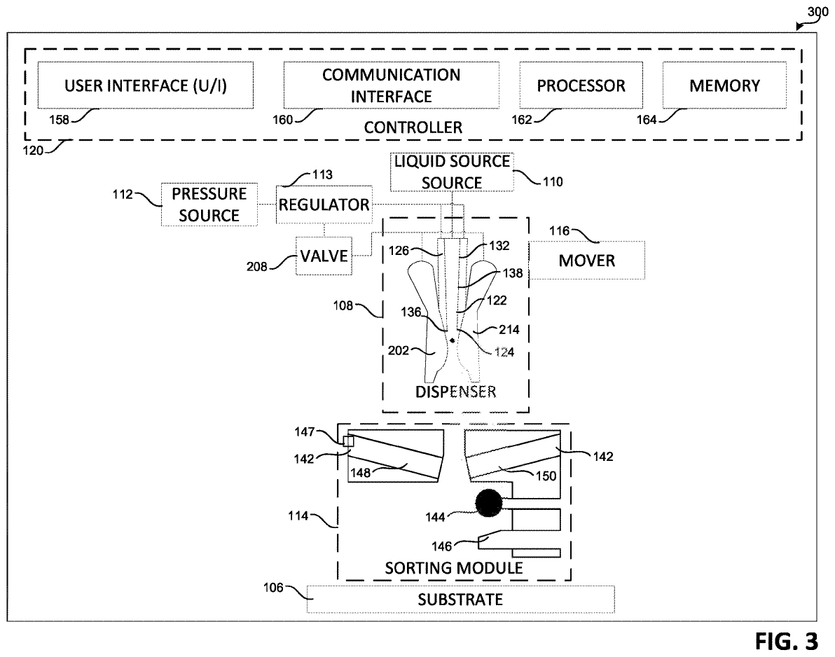

FIG. 3 is a schematic diagram of a system 300 in accordance with teachings of this disclosure. The system 300 is similar to the system 200 of FIG. 2. The system 300 is shown including the dispenser 108 but not including the second dispenser 154.

FIG. 4 is a schematic diagram of a system 400 in accordance with teachings of this disclosure. The system 400 is similar to the system 300 of FIG. 3. The dispenser 108 of FIG. 4 does not include the channel 126 that surrounds the tube 122. The dispenser 108 of FIG. 4 instead includes a pair of channels 402, 404 on either side of the tube 122. The flow path 128 couples the channels 402, 404 and the outlet 124 of the tube 122. The pressure source 112 is coupled to the channels 402, 404 and flows gas through the channels 126. The approach of the channels 402, 404 being on either side of tube 122 may be referred to as flow focusing.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a dispenser, comprising:
a tube having an outlet;
a channel surrounding the tube; and
a flow path coupling the channel and the outlet of the tube;
a liquid source to be coupled to the tube and to contain a liquid; and
a pressure source to be coupled to the channel;
wherein the liquid is to flow from the liquid source through the tube, and
wherein the pressure source is to flow gas through the channel to cause a droplet of the liquid to be dispensed from the outlet of the tube.

2. The apparatus of claim 1, wherein the pressure source is to flow the gas at a substantially constant flow rate.

3. The apparatus of claim 1, wherein the channel and the tube are coaxial.

4. The apparatus of claim 1, wherein the tube comprises a capillary.

5. The apparatus of claim 4, wherein the capillary comprises a glass capillary.

6. The apparatus of claim 4, wherein the capillary comprises a tip comprising the outlet.

7. The apparatus of claim 1, wherein the tube comprises an optical fiber.

8. The apparatus of claim 1, wherein the tube comprises a microfluidic channel.

9. The apparatus of claim 1, wherein the gas comprises air.

10. The apparatus of claims claim 1, further comprising a sorting module comprising a charging electrode, a sorting electrode, and a grounded waste channel.

11. The apparatus of claim 10, wherein the sorting module comprises an insulator.

12. The apparatus of claim 1, further comprising a second dispenser and a mover, the mover to carry the dispenser and the second dispenser.

13. The apparatus of claim 12, wherein the dispenser carries a first actuator and the second dispenser carries a second actuator.

14. The apparatus of claim 13, wherein the first actuator and the second actuator enable relative movement between the dispenser and the second dispenser.

15. The apparatus of claim 1, wherein the liquid comprises an emulsion.

16. An apparatus, comprising:
a dispenser, comprising:
a tube having an outlet at a flow path; and
a membrane valve at least partially defining the flow path and actuatable to a first position and a second position, the membrane valve being in the first position causes the flow path to have a first width and the membrane valve being in the second position causes the flow path to have a second width.

17. The apparatus of claim 16, wherein the dispenser comprises a channel surrounding the tube and the flow path coupling the channel and the outlet of the tube, further comprising a pressure source to be coupled to the channel, wherein the pressure source is to flow gas through the channel.

18. The apparatus of claim 16, wherein the first width is between about 60 micrometers and about 310 micrometers.

19. The apparatus of claim 16, wherein the second width is between about 60 micrometers and about 310 micrometers.

20. The apparatus of claim 16, wherein the first width is between about 60 micrometers and about 170 micrometers and the second width is between about 170 micrometers and about 310 micrometers.

21. The apparatus of claim 16, wherein the first width is between about 10 micrometers and about 5,000 micrometers.

22. The apparatus of claim 16, wherein the second width is between about 11 micrometers and about 10,000 micrometers.

23. The apparatus of claim 16, wherein the first width is between about 10 micrometers and about 170 micrometers and the second width is between about 170 micrometers and about 310 micrometers.

24. The apparatus of claim 16, further comprising a second membrane valve opposing the membrane valve and at least partially defining the flow path and actuatable to the first position and the second position.

25. The apparatus of claim 16, further comprising:
a liquid source to be coupled to the tube and to contain a liquid; and
wherein the liquid is to flow from the liquid source through the tube, and
wherein the membrane valve being in the first position causes a first droplet of the liquid to be dispensed from the outlet of the tube and wherein the membrane valve being in the second position causes a second droplet of the liquid to be dispensed from the outlet of the tube, the first droplet having a first size and the second droplet having a second size.

26. The apparatus of claim 16, further comprising a second dispenser coupled to the dispenser.

27. The apparatus of claim 16, wherein the dispenser comprises a pair of channels on either side of the tube and the flow path coupling the channels and the outlet of the tube, further comprising a pressure source to be coupled to the channels, wherein the pressure source is to flow gas through the channels.
